(19) United States
(12) Patent Application Publication
(10) Pub. No.: US 2007/0276678 A1
(43) Pub. Date: Nov. 29, 2007

(54) Provision of public information

(76) Inventor: Scott K. Nichols, Park City, UT (US)

Correspondence Address: Brake Hughes PLC, C/O Intellevate, P.O. Box 52050, Minneapolis, MN, 55402, US

(21) Appl. No.: 11/431,286

(22) Filed: May 10, 2006

(51) Int. Cl. G06Q 10/00; G06Q 30/00

(52) U.S. Cl. 705/1

(57) ABSTRACT

Techniques are described for determining agency information and event information, wherein the event information is related to a plurality of events, of which at least one event is associated with an individual. The event may be correlated with event-related agency information within the agency information, and a personalized marketing notification may be provided to the individual, the personalized marketing notification including the event-related agency information. In this way, highly-targeted and specialized marketing services and capabilities may be provided for members of service industries that are seeking to gain new clients and/or to strengthen relationships with existing clients.

### TECHNICAL FIELD

This description relates to providing public information

### BACKGROUND

The practical availability and usefulness of public information, such as, for example, governmental information, tax information, legal information (e.g., court-related or law enforcement information), or credit reporting information, varies widely. In some cases, knowledgeable members of the public may easily access public information, e.g., by using the Internet to access a website of a governmental agency, where the governmental agency may make efforts to ensure that the website organizes, presents, and explains any included information in a straight-forward and useful manner. In other cases, public information may be stored in an inaccessible (or difficult to access) or arcane manner. For example, some public information either may not be electronically accessible, and/or may have literal or practical restrictions on any access thereto. For instance, access to some public information may require registration or authorization, and the public information may be constructed, organized, or presented in a fashion that requires specialized knowledge to understand or use.

Due in part to the highly-specialized nature of certain types of public information, service industries exist in which industry members provide services to clients that include some type of mediation, interpretation, or defense for/of the client, with respect to these types of public information. For example, attorneys act on behalf of clients with respect to court proceedings, or mediate interactions between clients and various types of governmental agencies. In the latter example, for instance, tax attorneys may mediate between clients and the Internal Revenue Service, as may a Certified Public Accountant (CPA).

Marketing in such service-based industries may include, for example, advertisements in which the industry member (e.g., an attorney) advertises his or her specialty and expertise in a field. For example, a personal injury lawyer may advertise, e.g., in a television commercial, his or her expertise in medical malpractice claims.

### SUMMARY

According to one general aspect, a method includes but is not limited to determining agency information and event information, wherein the event information is related to a plurality of events, of which at least one event is associated with an individual. The method further includes but is not limited to correlating the event and event-related agency information within the agency information, and providing a personalized marketing notification to the individual, the personalized marketing notification including the event-related agency information.

According to another general aspect, a system includes but is not limited to an acquisition system that is operable to determine agency information and event information, wherein the event information is related to a plurality of events, of which at least one event is associated with an individual, and a notification system that is operable to correlate the event and event-related agency information within the agency information, to provide a personalized notification that is associated with the individual and that includes the event-related agency information.

According to another general aspect, a method includes but is not limited to correlating an event involving an individual with event-related agency information providing information related to a type of the event; generating a code; and providing the code to the individual in association with a notification of availability of the event and the event-related agency information.

According to another general aspect, a method includes determining agency information, determining an event from event information, the event being associated with an individual, determining an inferred event from the event, based on a rule associated with the event, correlating the inferred event with inferred event-related agency information within the agency information, and providing a personalized marketing notification to the individual, the personalized marketing notification including the inferred event-related agency information.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system for providing public information.

FIG. 2 is a flowchart illustrating example operations of the system of FIG. 1.

FIGS. 3A and 3B are illustrations of event information and event-related agency information, respectively, used in the system of FIG. 1.

FIG. 4 is an illustration of a generic notification used in the example of FIG. 1.

FIGS. 5A and 5B are illustrations of provided information of the system of FIG. 1, including a personalized notification.

FIG. 6 is a flowchart illustrating an alternative implementation of the system of FIG. 1.

### DETAILED DESCRIPTION

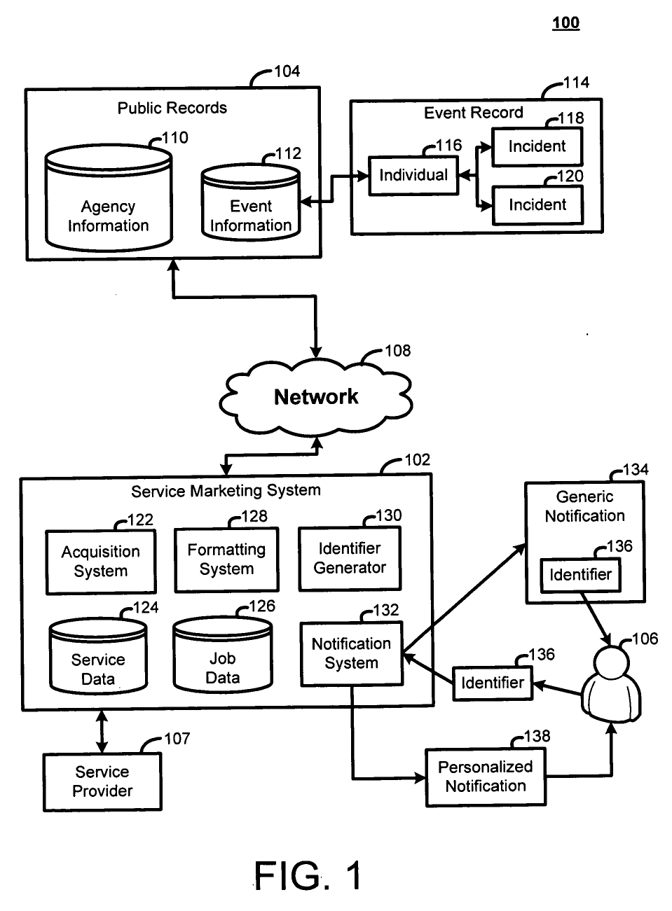

FIG. 1 is a block diagram of a system 100 for providing public information. In the example of FIG. 1, the system 100 is operable to provide highly-targeted and specialized marketing services and capabilities for members of service industries that are seeking to gain new clients and/or to strengthen relationships with existing clients.

In the system 100, a service marketing system 102 may be operable to provide public information from public records 104 to an individual 106, where the provided public information is related to a unique event in which the individual 106 was a participant. For example, the provided public information may inform the individual of possible penalties related to the event, or may inform the individual 106 of the possibility of related services and/or responses that may be employed in reaction to the event. As such, the provided public information may be of particular and personalized value to the individual 106, and the provision of such personalized information to the individual 106 as part of a marketing or advertising campaign may serve to persuade the individual 106 of a use, value, and/or expertise of a service provider 107.

For example, the service marketing system 102 may include, or be implemented by, a marketing agency or service acting for, or on behalf of, the service provider 107, e.g., an attorney who is seeking to expand or strengthen a client base. As such, in some implementations, the service marketing system 102 may be considered to be a third-party provider acting separately from the service provider 107 (e.g., an attorney or other customer of the service marketing system 102). In other implementations, the service marketing system 102 may represent a wholly or partially automated system that may be deployed, in whole or in part, at a local system of the service provider 107, and/or that may be accessible to the service provider 107, perhaps over a network 108 (which may include, e.g., a publicly-available network, such as the Internet, or a private network over which the service marketing system 102 communicates with the service provider 107).

The public records 104 may refer to any data or information that relates or applies to an individual or group of individuals, such as, for example, the individual 106. For instance, and to reiterate the examples above, the public information may include governmental information, tax information, legal information (e.g., court-related or law enforcement information), or credit reporting information. More specifically, the public records 104 may include agency information 110, which is generally not associated with, but is applicable to, the individual 106, and also may include event information 112, which includes event information that is related to a unique event in which the individual 106 was a participant.

For example, the agency information 110 may include data related to laws, statutes, or rules that are codified by a local, state, or national legislature or administrative agency. Such data is therefore, as just mentioned, generally not specific to the individual 106, but may be applicable or useful to the individual 106 in a specific circumstance. In contrast, the event information 112 includes an event record 114, which includes event information related specifically to the individual 106, e.g., event information that describes an event in which the individual was involved.

For example, the event record 114 may include event information regarding a circumstance in which the individual was arrested or detained, or otherwise involved in a violation or alleged violation of the law. As another example, the event record 114 may include event information regarding a circumstance in which the individual 106 was delinquent on a loan (or other) payment, defaulted on a loan, denied a loan, or declared bankruptcy, or otherwise suffered a credit-damaging event.

The event record 114 may include information regarding a filing or request provided by the individual 106 to an agency or authority associated with the agency information. For example, the individual 106 may file a request for a business license (e.g., to open a business in a municipality), or may file a building permit to construct or improve a dwelling or other structure. The individual 106 may file a complaint with a governmental agency, e.g., against the same or different agency, or against a separate business. The individual 106 also may file a lawsuit, or may have a lawsuit filed against him or her, or may have a judgment issued for or against him or her (e.g., by a court, or by another governmental agency, such as the Department of Motor Vehicles (DMV)).

Generally, then, the event(s) of the event information 112 may include any event in which the individual 106 may have been involved, or in which the individual 106 may currently be involved or may be involved in the future. Further, as described in more detail below, the event information 112 may include at least some event records 114 to which at least some agency information 110 may apply. That is, for example, the agency information 110 may include a large number of laws, codes, statutes, or rules, while the event information 112 may include a large number of event records 114. Moreover, although illustrated in FIG. 1 (for the sake of clarity and convenience) as being included within the public records 114, it should be understood that the agency information 110 and the event information 112 may be stored in separate locations (e.g., separate databases and/or separate sites on the network 108, or on different networks), in separate formats, and perhaps requiring different interface techniques. Further, the agency information 110 may itself include a large number of the same or different types of agency information, only some of which may be related to a given (one or more of the) event record(s) 114, where the included agency information, again, may be stored using different locations, formats, and/or interfaces. Similarly, but conversely, the event information 112 may include a large number of event record(s) 114 that may be stored using different locations, formats, and/or interfaces, where only some of the event record(s) 114 may relate to any or all of the agency information 110

In the example of FIG. 1, the event record 114 illustrates that an event may include one or more incidents. For example, the event record 114 may include an individual record 116 associated with the individual 106, which is associated within the event record 114 with an incident 118 and an incident 120. Generally, the incidents 118, 120 may refer to multiple incidents that occurred within (or related to) the context of the overall event. For example, the individual 106 may be stopped for speeding and reckless driving, and, during a subsequent stop by a police officer, may be arrested for driving while intoxicated. In this example, the overall event of the detainment and arrest of the individual 106 may include the three incidents of speeding, reckless driving, and driving under the influence. That is, each incident 118, 120 may refer to a subset of (a type of) the event information 112 that may be related to separate portions of the agency information 110. In the example just given, for example, each of the three incidents may be related to different laws or ordinances stored in the agency information 110, since each may occur independently of the other.

As described in more detail below, then, the service marketing system 102 is operable to correlate an event (as represented in the event record 114) with a subset of the agency information 110 (i.e., event-related agency information) that as associated with the event. Conversely, the service marketing system 102 may correlate a selected subset of the agency information 110 with corresponding events of a plurality of the event record(s) 114.

In this way, for example and as described in more detail herein, the service marketing system 102 may provide a marketing service to the service provider 107, who wishes to market to the individual 106. As referenced above, the service provider 107 may include, for example, attorneys, accountants, doctors or other medical providers, or any other professional involved in providing services to clients. For example, the service provider 107 may have specialized knowledge related to a particular class of the agency information 110, such as a criminal defense attorney with knowledge of a criminal code.

The service provider 107 may wish to minimize a cost of a marketing campaign, while maximizing an effectiveness of the campaign. By using the service marketing system 102, the service provider 107 may market only to those individuals who are known, or reasonably suspected, to currently be in need of a service of the service provider 107. Moreover, the service marketing system 102 allows the service provider 107 to differentiate him or herself in the marketplace by providing useful and/or motivational information to the individual 106.

For example, where the individual 106 was involved in an event in which the individual was charged with reckless driving or other traffic violation, the individual 106 may not fully appreciate a need for, or benefit of, a skilled attorney. By correlating event-related agency information from the agency information 110, such as, for example, portions of the traffic and/or criminal code that set forth possible penalties for the relevant violation(s) with the (corresponding for the sake of this example) event record 114 (e.g., from a list of traffic violations made public as part of a police record), the service marketing system 102 may alert the individual 106 to the penalties that may apply, and may thereby persuade and/or motivate the individual 106 to contact the service provider 107 (e.g., attorney) for further assistance.

Thus, the service marketing system 102 includes, in the example of FIG. 1, an acquisition system 122 that is operable to acquire relevant information from the public records 104, i.e., from the agency information 110 and the event data 112. For example, the acquisition system 122 may be operable to download files from servers, download e-mail attachments, perform screen scraping (e.g., parsing Hyper-Text Transfer Protocol (HTML) code in web pages to mine desired patterns of content), or otherwise obtain information from the public records 104. For example, a software agent may be used to monitor the public records 104 and/or periodically download desired or pre-identified types of information therefrom. In some implementations, the acquisition system 122 may include a query generator that is operable to generate queries against databases of the public records 104, based on desired criteria.

The acquisition system 122 also may obtain useful information from other sources, including sources that are internal either to the service marketing system 102 or to the service provider 107. For example, the acquisition system 122 may obtain information from service data 124, which refers generally to information about the service provider 107 that may be relevant both to specific event information and event-related agency information (e.g., an arrest for an offense and code sections relevant to the type of offense, respectively). For example, where the service provider 107 refers to a law firm having a plurality of attorneys, the service data 124 may include information about a particular expertise of a particular attorney at the firm, relative to the event information and/or event-related agency information.

The acquisition system 122 also may be responsible for obtaining address or other information for contacting the individual 106 as part of a marketing campaign. For example, the acquisition system 122 may determine such information from the event record 114 (e.g., from the individual record 116). In other implementations, the acquisition system 122 may use an identification of the individual 106 derived from the event record 116, and/or may use known techniques for obtaining address or other contact information for the individual 106 (e.g., on-line white pages or people-finder services). In the latter case, the service marketing system 102 may not be able to ascertain an identity or contact information for the individual 106 with any certainty, and ultimately may send information not only to the individual 106, but also to other individuals determined by the acquisition system 122 (e.g., individuals with a same or similar name as the individual 106).

Information associated with an instruction, operation, and/or result(s) of the acquisition system 122 may be provided in, or in conjunction with, job data 126. That is, the term job in this context may refer to an internal device or storage scheme for managing and tracking requirements of the service provider 107, e.g., with respect to a particular marketing campaign. For example, the service provider 107 may be associated with a unique job that contains information about a desired operation of the service marketing system 102. That is, a job may indicate desired types of event-related agency information and/or events that are desired by the service provider 107. For example, the job may specify a type of the agency information 110 that is desired, and/or events from the event information 112 associated with a geographical location (e.g., when an attorney wishes to represent local clients and/or non-local clients who committed a local offense). Of course, it should be understood that the service provider 107 is intended to represent one or more service providers, so that the job data 126 may contain a plurality of jobs, where each such service provider is associated with one or more of the jobs.

A formatting system 128 may be used to clean or otherwise (re-)format data in the job data 126. For example, the formatting system 128 may appropriately title case words in the job data 126 (i.e., may re-format words in all-capital letters to use appropriately capitalized/un-capitalized letters). As another example, the formatting system 128 may check address information associated with the individual 106, e.g., to include or correct zip code information, or otherwise make ready at least some of the job data 126 for delivery to the individual 106.

In the example of FIG. 1, an identifier generator 130 is operable to generate a unique (for purposes of operation of the service marketing system 102) alpha-numeric identifier that is associated with a specific job of the job data 126, e.g., with the specific event record 114 of the event information 112. As described below in more detail, the identifier may be used to query the job data 126 (or included data and/or data tables stored therein) to determine personalize information for the individual 106.

For example, the job data 126 may include, or be associated with, a first table of one or more relational databases that stores the generated identifier(s), a second table that stores event information acquired by the acquisition system 122 from the event information 112 in response to requirements of a specific job of the job data 126, and a third table that stored event-related agency information acquired from the agency information 110, also in response to a job of the job data 126. That is, the acquisition system 122 may be responsible for obtaining relatively large sets of information from the agency information 110 and/or the event information 112. Individual units of the event-related agency information may be related to each of a plurality of events/individuals, while individual events may each be related to different units of the event-related agency information. Therefore, it may be unnecessarily duplicative to store discrete datasets in which an event (individual) is associated with its corresponding event-related agency information, and, instead, as just described, the information may be stored in separate tables and aggregated when needed or desired by the service marketing system 102 and/or the service provider 107 for provision to the individual 106.

For example, a notification system 132 may be used to provide marketing information as described herein to the individual 106. In the implementation of FIG. 1, the notification system 132 determines an identity and/or contact information for the individual 106, i.e., for all individuals involved in a marketing campaign for the service provider 107 and for whom event information and/or event-related agency information has been (or will be, or could be) collected. The notification system 132 may then send a generic notification 134 to the individual 106, e.g., by mail, e-mail, and/or telephone. The generic notification 134 may, for example, identify the service provider 107 and general services that are provided, without referring fully and/or specifically to personalized information associated with the individual 106 and obtained from the agency information 110 and/or the event information 112.

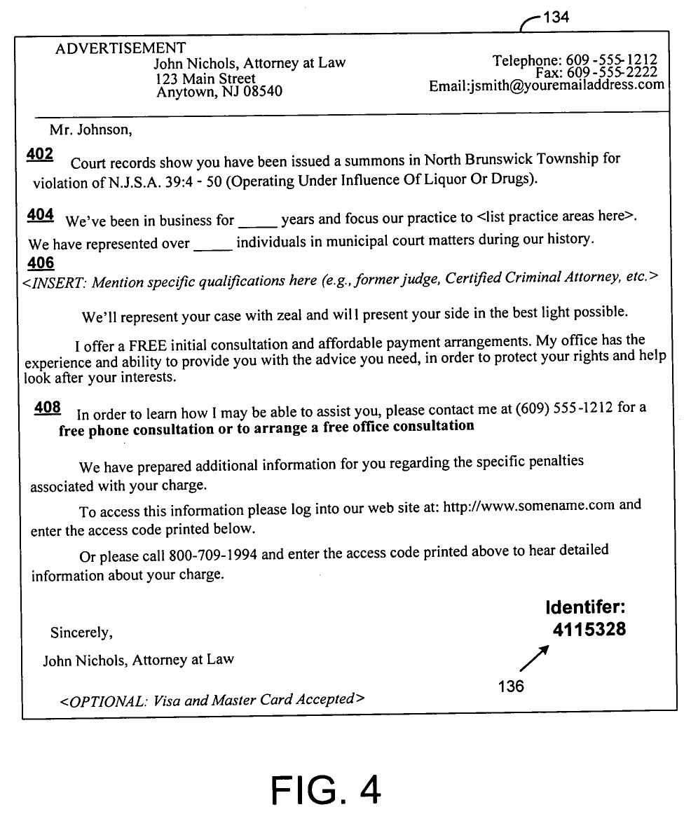

One example of the generic notification 134 is provided below with respect to FIG. 4, but, generally speaking, it should be understood that many types of the generic notification 134 may be used. For example, in one implementation, the generic notification 134 may merely identify the service provider 107 and provided services, without any reference to the individual 106 or the associated event. In other implementations, the generic notification 107 may include a high-level reference to the event, e.g., by stating that the individual 106 has been charged with a particular violation and/or is in particular need of a provided service.

The generic notification 134 also may include an identifier 136 generated by the identifier generator 130, with instructions that the individual 106 may contact the service marketing system 102 and/or the service provider 107 to receive more personalized or helpful information. In FIG. 1, then, the individual 106 is illustrated as providing the identifier 136 to the notification system 132, which may be accomplished, for example, by going to a website associated with the service marketing system 102 or the service provider 107, or using an automated phone system, or sending an e-mail to a provided e-mail address.

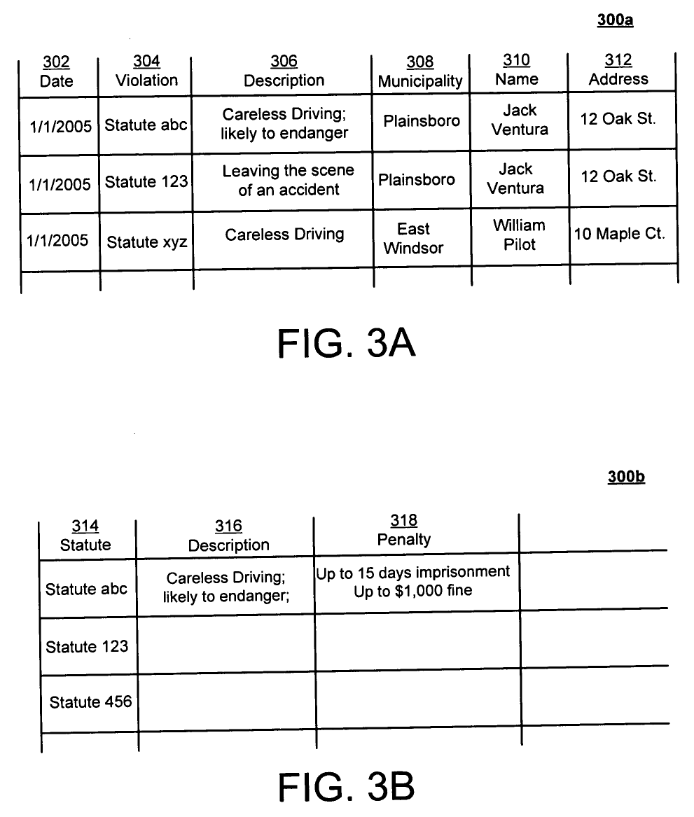

Upon receiving the identifier 136, the notification system 132 may, as referenced above, query the collected job data 126, using the identifier 136, to access event information and event-related agency information that is stored therein. For example, the notification system 132 may first use the identifier 136 to query a relational database storing event information related to the individual 106, and stored in association therewith (an example of which is illustrated in FIG. 3A). Then, using the identifier 136 and/or the resulting event information for the individual 106, the notification system 132 may query a second relational database (an example of which is illustrated in FIG. 3B) storing agency information obtained from the agency information 110 to obtain event-related agency information for the individual 106.

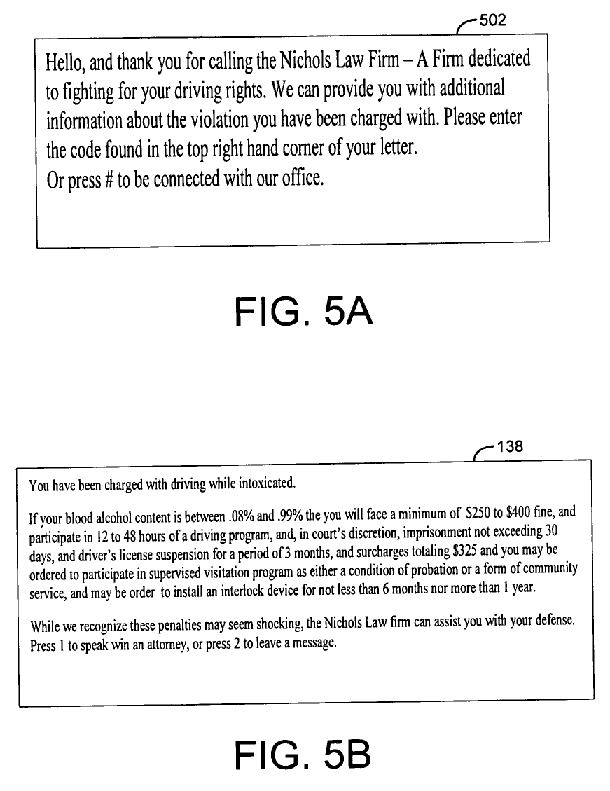

Then, a personalized marketing notification 138, also referred to as a personalized notification, may be generated and sent to the individual 106, using any of the communications techniques described above, or other communications techniques. The personalized notification 138 (an example of which is illustrated in FIG. 5B) may thus include specific event-related agency information (as well as, in some implementations, the service data 124) that may be of particular use and interest to the individual 106.

In this way, the individual 106 may receive information that is of particular use and value, and may believe or infer that that service provider 107 is capable of providing a helpful service. Additionally, or alternatively, the service marketing system 102 provides the service provider 107 with an opportunity to provide yet further information or service to the individual 106, e.g., when (or after) the individual 106 contacts the service marketing system 102 and/or the service provider 107 to obtain the personalized notification 138. For example, upon receiving the identifier 136 from the individual 106, the job data may be updated to reflect this communication. Then, the service provider 107 may be made aware of the communication, and may then, or thereafter, contact the individual 106 to discuss the circumstances or needs of the individual 106, and/or to further describe services provided by the service provider 107.

Accordingly, the service provider 107 is provided with the opportunity and ability to market his or services in a cost-effective and time-effective manner, while maximizing an effect of the marketing with respect to establishing or maintaining a client base. Further, the individual 106 may be provided with a valuable service, the need for which the individual 106 may not previously appreciate until receipt of the personalized notification, and/or may be assisted in selecting the service provider 107 from number of (otherwise, from the viewpoint of the individual 106, indistinguishable) service providers.

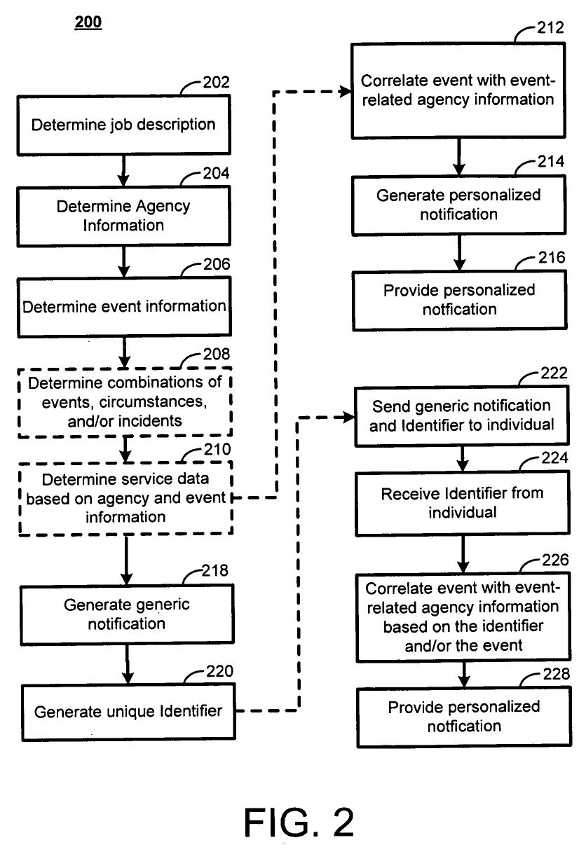

FIG. 2 is a flowchart 200 illustrating example operations of the system of FIG. 1. In the example of FIG. 2, the service marketing system 102 initially determines a job description (202). For example, the service marketing system 102 may receive a request from the service provider 107 for a desired job, where the request may describe a type of event, or event characteristic or parameter that is a focus of client generation/development for the service provider 107. For example, where the service provider 107 is a criminal defense attorney, the job description may specify certain sections of the criminal code in which the service provider 107 has specialty and experience in providing defense.

The job description may specify a type or characteristic of desired agency information, as well as a type or characteristic of desired event information. In this regard, it should be understood that desired agency information and event information may be specified or described within the job description in the same, different, or overlapping manner(s), for example, according to a preference of the service provider 107, or based on an operation of the service marketing system 102, or based on a format or storage/transmission protocol associated with the agency information 110 and the event information 112.

For example, the job description may specify either the desired agency information and/or the desired event information with respect to one or more of a statue, an ordinance, a law, a code section, a regulation, a rule, a municipality, a violation, a geographical region, or a judgment. For instance, the service provider 107 may request a job, the job specifying agency information related to a particular municipality that may have implemented an ordinance against certain actions that are particular to the municipality. In such cases, the individual 106 may not be aware of penalties associated with violating the local ordinance, so that the personalized notification 138 may be useful to the individual 106 in explaining potential consequences.

The event information 112 also may be searched according to a type of violation described therein, such as a type of speeding or traffic violation, and/or based on a geographical region (e.g., whether the individual committing the traffic violation is in-state or out-of-state). The event information 112 also may be searched based on a period of time of occurrence of the event(s), so that, for example, the job description may request all of a certain type of event (e.g., arrests for a certain crime) that occurred in the last week or month.

The event information 112 and the agency information 110 may be determined according to a common parameter, including, for example, any of the parameters just listed. That is, for example, the job description may specify a particular regulation that is included in the agency information 110 and that is included in one or more events of the event information 110.

In some implementations, the service marketing system 102 may be wholly or partially unique to the public records 104. For example, as referenced above, the agency information 110 and the event information 112 may have different formats, locations, and interfaces than one another, and than other sets of agency/event information. As a result, it may be advantageous to configure the service marketing system 102 to a particular type of agency/event information, prior to deployment for use by the service provider 107. For example, one implementation of the service marketing system 102 may be used in conjunction with the New Jersey Municipal Court Traffic information, New Jersey Court Criminal information, Pennsylvania Traffic Information, or the Philadelphia Traffic information. In this way, components of the service marketing system 102 may be optimized for interactions with particular types or instances of the public records 104.

In some implementations, the job description may merely specify desired event information, and the acquisition system 122 may include a rule engine for determining the types of agency information that may be required, based on the event information. In other implementations, the agency information 110 may be downloaded virtually in whole for local storage/access (especially when relatively small in size; the downloaded agency information may then later be queried based on specific event information and/or the identifier 136). In still other implementations, the desired agency information may be specified with more precision or detail, to minimize a difficult of later queries processed against the specified agency information.

Based on the job description, agency information may be determined (204) and/or event information may be determined (206). For example, desired types and/or instances of event information may be downloaded from the event information 112 of the public records 104, using information from the job description, such as just described. Similarly, data from the agency information 110 may be obtained in a manner specified by or for the service provider 107. In various implementations, either the desired agency information or the desired event information may be determined first, or, in other implementations agency information and event information may be determined at the same or overlapping times.

In FIG. 1, the single event record 114 is illustrated, although of course multiple event (records)s may be obtained, so that, more generally, it may be seen that in some implementations, various combinations of events, circumstances, and/or incidents may be determined (208). For example, a first event or incident may be associated with a recent violation of a law by the individual 106, while a second event or incident may be associated with a violation of the same or different law that occurring concurrently or in the past. In this way, for example, event-related agency information that is obtained and correlated with the event information may be based on, or may include, information that takes into account such a combination. For example, such pluralities of offenses may carry the potential of different or stiffer penalties than each one alone.

Service data may be determined, based on the determined (event-related) agency information and/or the determined event information (210). For example, as described above, the acquisition system 122 may access the service data 124, in order to supplement the agency/event information with service data associated with the service provider 107 that is determined to be of interest to the individual 106. In this way, particular abilities, expertise, or other service-related information (e.g., a convenient location of the service provider 107 relative to the individual 106) may ultimately be included in the personalized notification 138.

At this point, in some implementations, a determined event(s) may be correlated with corresponding event-related agency information (212). For example, the notification system 132 may select or determine an event, and may then query a database in which the acquired agency information is stored. For example, the event may include a filing of bankruptcy by the individual 106, where a query against agency information downloaded from the agency information 110 and based on such an event may return event-related agency information that includes, for example, relevant portions of the bankruptcy laws, or consequences to a credit rating that may occur after bankruptcy.

Then, a personalized notification may be generated (214). For example, the correlated event and event-related agency information (and potentially the service data) may be included within a template or form that provides general information about the service provider 107, and that is addressed to the individual 106. As referenced above, the information included in the personalized form may be (re-)formatted or otherwise cleaned or improved in appearance, either during the generation of the personalized notification 138, or earlier in the process 200.

Then, the personal notification may be provided (216). For example, and as already described, the personalized notification may be sent by mail or e-mail, or may be provided over the telephone.

In other implementations, and as described with respect to some of the examples of FIG. 1, a generic notification may be generated (218). In these cases, for example, a letter, e-mail, or voicemail may be generated that includes basic or general information about the service provider 107 and/or provided services. In such cases, little or no information determined based on the job description (e.g., event information, event-related agency information, and/or service data) need be included, although, in some implementations, a general reference to such information, or to an availability of such information, may be included in the generic notification 134.

Before, concurrently with, or after the generation of the generic notification, a unique identifier may be generated (220). For example, the identifier generator 130 may generate the identifier 136. The generic notification and unique identifier may then be correlated or combined and sent to the individual (222). For example, as shown in FIG. 1, the generic notification 134 may include the identifier 136, and may be sent to the individual 106, for example, by mail, e-mail, or voicemail.

By receiving the generic notification 134 with the identifier 136, the individual 106 is informed of the existence and availability of personalized information, and is provided with a technique for obtaining the personalized information. For example, the generic notification 134 may include an address, e-mail address, website address, or phone number that the individual 106 may use to obtain the personalized information, along with instructions on how to do so, i.e., by providing the identifier to the service marketing system 102.

Accordingly, the identifier may be received (224) from the individual 106, by way of one of the described technique, or another technique(s), not mentioned. In response, the identifier may be used to determine the relevant event, and the identifier and/or the event may be correlated with appropriate event-related agency information (226), as described above (212).

Then, the correlated event and event-related agency information may be included in a personalized notification, e.g., the personalized notification 138, and provided to the individual (228), using any of the techniques described above (216), or other techniques.

FIGS. 3A and 3B are illustrations of event information 300a and event-related agency information 300b, respectively. In FIG. 3A, a column 302 includes a date of an event, a column 304 includes a violated statute associated with the event, and a column 306 includes a description of the statute and/or the event. Further, a column 308 includes a municipality in which the event occurred and/or in which the individual 106 resides, while a column 310 includes a name of the individual(s) 106, and a column 312 includes an address of the individual 106.

Accordingly, and based on the above description, it will be understood that the event information 300a may be determined or obtained by the acquisition system 122 from the event information 112, based on the job description. For example, the job description may specify any of the information included in one or more of the columns 302-312, so that the acquisition system 122 may query the event information 112 based on such information to obtain the event information 300a as a subset of the event information 112 (e.g., by querying the event information 112 for all events that occurred on Jan. 1, 2005, as specified in the column 302).

In FIG. 3B, the event-related agency information 300b may include a column 314 that lists a number of different statutes, while a column 316 includes a description of the statute, and a column 318 includes a penalty for violating the statute. As in FIG. 3A, then, the event-related agency information 300b may be determined from the agency information 110 based on any of the information in the columns 314-318, and may be correlated with the event information 300a based on this information, or other information.

For example, if the event information 300a is determined from the event information 112, then information from the column 304 may be compared to information in the column 314 of the event-related agency information 300b. In this case, it may be determined that the “statute abc” is both a statue included in the statute column 314 (i.e., a general recitation or description of the “statute abc,” or relate information, without reference to any particular individual) and a statute specified in the violation column 304 as having been violated. In this way, the notification system 132 may provide correlated event-related agency information (i.e., a first row of the event-related agency information 300b) in conjunction with event information (e.g., from a first row of the event information 300a) to the individual “Jack Ventura” associated with the event. Then, as already described, this information may be provided to the individual 106 as part of a marketing campaign of the service provider 107.

Further, it may be seen in FIG. 3A that the event information 300a includes two incidents associated with the individual “Jack Ventura,” as shown in the first two rows of the event information 300a (i.e., the first two rows each correspond to the incident(s) 118 and 120, and both rows together form the event record 114). In this case, the correlation of the event information 300a with the event-related agency information 300b may include both of the incidents associated with the individual “Jack Ventura,” so that the personalized notification 138 also may reflect the two incidents, as described above.

FIG. 4 is an illustration of the generic notification 134 of FIG. 1. In FIG. 4, a letter is illustrated in which a section 402 is included that identifies or references an event in which the addressee was involved. Thus, in this example, the generic notification 134 is not completely generic to the individual 106, although, in other implementations, the section 402 may be omitted. In the section 402, event information includes court records, which provide the information that the individual 106 has been issued a summons for operating under the influence.

A section 404 is included that provides general background information about the service provider 107. A section 406 is included that includes an example of the service data 124, e.g., provides specific, relevant qualifications and abilities of the service provider 107 that relate to the section 402. A section 408 informs the individual 106 that additional, personalized information has been prepared, and explains that (and how) the included identifier 136 may be used to obtain the additional information. In the example of FIG. 4, the section 408 provides a phone number that the individual may call to enter the identifier and receive the personalized notification 138.

FIGS. 5A and 5B are illustrations of information provided in response to the identifier 136, including the personalized notification 138. In FIG. 5A, a message 502 is illustrated that is provided to the individual 106 upon contacting the service provider 107. The message 502 represents a voice message that is provided to the individual 106 by way of an automated telephone service. The message 502 provides an additional marketing opportunity for the service provider 107, since, for example, a positive comment such as, “dedicated to fighting for your driving rights” may be included. The message 502 informs the individual 106 that the identifier 136 may be entered, or that the service provider 107 may be contacted directly, if desired.

FIG. 5B illustrates an example of the personalized notification 138. In the example of FIG. 5B, the personalized notification 138 informs the individual of penalties associated with operating under the influence. The personalized notification 138 also provides the individual with opportunities to contact the service provider 107 directly, or to leave a message for the service provider. Thus, the personalized notification 138 provides another opportunity for the service provider 107 to cast him/herself in a positive light.

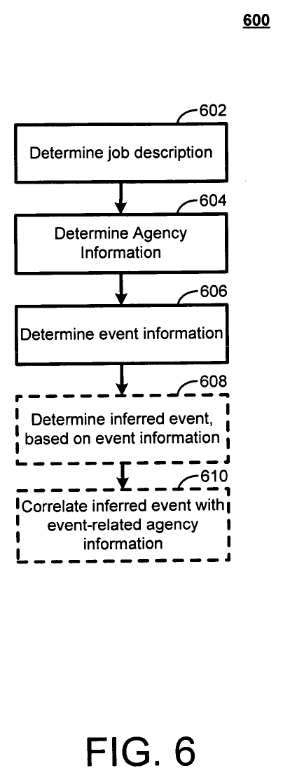

FIG. 6 is a flowchart 600 illustrating an alternative implementation of the system 100 of FIG. 1. With reference to FIG. 6 and to the discussion below, it should be understood that the flowchart 600 illustrates a specific configuration of the service marketing system 102, e.g., in which components of the service marketing system 102 are programmed or otherwise configured to provide the described functionality.

In the example of FIG. 6, as described with respect to FIG. 2, a job description is determined (602), agency information is determined (604), and/or event information is determined (606). Then, an inferred event is determined, based at least on the event information (608).

For example, as referenced above, an event may include a judgment against the individual 106 by a court, or by the DMV, or other governmental agency. If such a judgment is very large, or if the event information includes a default on the judgment by the individual 106, then an inferred event, e.g., a current or future bankruptcy of the individual 106, may be determined.

For example, the acquisition system 122 and/or the notification system 132 may be configured to implement a rule engine that executes inference rules based on the event information. For example, a rule may be implemented that states that a judgment amount over a certain quantity (e.g., $10,000, or $50,000) may trigger inference of the inferred event (e.g., bankruptcy, or defaulted mortgage or other loan). Many other examples of such rules and inferences may be implemented. For example, the service provider 107 may include an insurance broker, and an event(s) related to a number of traffic tickets received by the individual 106 may trigger an inferred event of lost insurance by the individual 106.

Accordingly, the inferred event may be correlated with event-related agency information (610). For example, in the examples just given, the inferred event of bankruptcy may be correlated with event-related agency information associated with relevant bankruptcy laws. Or, the inferred event of lost insurance may be correlated with event-related agency information associated with state insurance requirements.

In another example of the operations of FIG. 6, it may be the case that the event includes a filing for a business license by the individual 106. Then, the inferred event may include a need for a trademark filing, or other business-related needs. Accordingly, the (inferred) event-related agency information may include information regarding trademark filings or procedures, such as might be obtained from the U.S. Patent Office, and/or service data related to experience of Trademark attorneys of the service provider 107.

As yet another example, the service provider 107 may provide or endorse radar detectors, so that detection of an event involving the individual receiving a speeding ticket may lead to an inferred event of the individual needing a radar detector. In this case, the event-related agency information may include information from the relevant statute(s) regarding penalties for speeding, and/or may include statistics from the American Automobile Association (AAA) regarding speeding and/or the user of radar detectors.

It should be understood with respect to FIG. 6 that any of the operations described above, e.g., with respect to FIGS. 1 and 2, may be included in, or associated with, the operations of the flowchart 600. For example, a generic notification and/or identifier may be generated and sent to the individual, and a personalized notification may be sent to the individual.

As described, techniques allow for efficient, effective marketing by a service provider to an individual. By providing the personalized marketing notification with included event-related agency information, the service provider 107 is able to illustrate an ability to provide services related to obtaining, providing, understanding, or using such agency information in the service of the individual 106.

Of course, techniques described herein are merely examples, and many other modifications and implementations are possible. For example, the individual 106 may include, or refer to, more than one individual, or to an entity, e.g., a corporate entity. As another example, the rule engine described with respect to FIG. 6 may include an artificial intelligence engine configured to determine the inferred event from the event information.

Thus, while certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

What is claimed is:

1. A method comprising:
determining agency information and event information, wherein the event information is related to a plurality of events, of which at least one event is associated with an individual;
correlating the event and event-related agency information within the agency information; and
providing a personalized marketing notification to the individual, the personalized marketing notification including the event-related agency information.

2. The method of claim 1 wherein determining agency information and event information comprises:
determining the agency information and the event information, based on a job description.

3. The method of claim 1 wherein determining agency information and event information comprises:
determining the agency information with respect to one or more of a statute, an ordinance, a law, a code section, a regulation, a rule, a municipality, a violation, a judgment, or a geographical region.

4. The method of claim 1 wherein determining agency information and event information comprises:
determining the event information with respect to a period of time of occurrence of the plurality of events.

5. The method of claim 1 wherein determining agency information and event information comprises:
determining the agency information and the event information with respect to a common parameter.

6. The method of claim 1 wherein determining agency information and event information comprises:
determining a job description that describes the agency information as a sub-set of available agency information, and that describes the event information as a sub-set of available event information; and
determining the agency information from the available agency information and the event information from the available event information, based on the job description.

7. The method of claim 1 wherein correlating the event and event-related agency information within the agency information comprises:
determining the event-related agency information as a sub-set of the agency information, based on a matching of the agency information with the event.

8. The method of claim 1 wherein correlating the event and event-related agency information within the agency information comprises:
correlating the event and the event-related agency information with service data of a service-providing customer.

9. The method of claim 1 wherein correlating the event and event-related agency information within the agency information comprises:
storing an identifier associated with the event; and
associating the event and the identifier with the event-related agency information.

10. The method of claim 1 wherein correlating the event and event-related agency information within the agency information comprises:
determining a first event and a second event of the event information; and
determining the event-related agency information based on a combination of the first event and the second event.

11. The method of claim 1 wherein correlating the event and event-related agency information within the agency information comprises:
determining a first incident and a second incident of the event; and
determining the event-related agency information based on a combination of the first incident and the second incident.

12. The method of claim 1 wherein correlating the event and event-related agency information within the agency information comprises:
determining the event;
determining an inferred event, based on a rule associated with the event; and
determining the event-related agency information, based on the inferred event.

13. The method of claim 1 wherein providing a personalized marketing notification to the individual comprises
providing a generic notification to the individual in conjunction with the identifier;
receiving the identifier from the individual; and
providing the personalized notification to the individual, in response to the receiving of the identifier.

14. A system comprising:
an acquisition system that is operable to determine agency information and event information, wherein the event information is related to a plurality of events, of which at least one event is associated with an individual; and
a notification system that is operable to correlate the event and event-related agency information within the agency information, to provide a personalized notification that is associated with the individual and that includes the event-related agency information.

15. The system of claim 14 wherein the acquisition system is operable to determine the event information with respect to a period of time of occurrence of the plurality of events.

16. The system of claim 14 wherein the acquisition system is operable to determine a job description that describes the agency information as a sub-set of available agency information, and that describes the event information as a sub-set of available event information, and is further operable to determine the agency information from the available agency information and the event information from the available event information, based on the job description.

17. The system of claim 14 wherein the notification system is operable to generate a code and to store the event and event-related agency information in association with the code.

18. The system of claim 17 wherein the notification system is operable to provide the code to the individual and to receive the code from the individual at a later time, and further operable to provide the personalized notification to the individual in response thereto.

19. A method comprising:
correlating an event involving an individual with event-related agency information providing information related to a type of the event;
generating a code; and
providing the code to the individual in association with a notification of availability of the event and the event-related agency information.

20. The method of claim 19 comprising:
receiving the code from the individual; and
providing the event and the event-related agency information to the individual, in response to the receiving of the code.

21. A method comprising:
determining agency information;
determining an event from event information, the event being associated with an individual;
determining an inferred event from the event, based on a rule associated with the event; and
correlating the inferred event with inferred event-related agency information within the agency information; and
providing a personalized marketing notification to the individual, the personalized marketing notification including the inferred event-related agency information.

22. The method of claim 21 wherein determining an inferred event from the event comprises:
accessing the rule to determine an association of the event with the inferred event, the inferred event including a possible event that happened, is happening, or will happen in association with the individual.
